(19) United States
(12) Patent Application Publication
(10) Pub. No.: US 2024/0077320 A1
(43) Pub. Date: Mar. 7, 2024

(54) VEHICLE CONTROLLER, METHOD, AND COMPUTER PROGRAM FOR VEHICLE CONTROL

(71) Applicant: TOYOTA JIDOSHA KABUSHIKI KAISHA, Toyota-shi (JP)

(72) Inventors: Takehiko Hanada, Hiratsuka-shi (JP); Wataru Kawashima, Nisshin-shi (JP)

(21) Appl. No.: 18/447,612

(22) Filed: Aug. 10, 2023

(30) Foreign Application Priority Data
Aug. 24, 2022 (JP) 2022-133477

(51) Int. Cl. G01C 21/34; G01C 21/30

(52) U.S. Cl. CPC G01C 21/3461; G01C 21/30

(57) ABSTRACT

A vehicle controller includes a processor configured to estimate the position of a vehicle by comparing an image representing an area around the vehicle generated by a camera mounted on the vehicle with map information, set a planned trajectory of the vehicle along a lane including the estimated position of the vehicle by referring to the map information, detect a stationary object in the area around the vehicle from the image or a ranging signal obtained by a distance sensor mounted on the vehicle for detecting the distance to an object in the area around the vehicle, determine whether the detected stationary object is on the planned trajectory, and determine that the estimated position of the vehicle is incorrect, when the stationary object is on the planned trajectory.

### FIELD

The present invention relates to a vehicle controller, a method, and a computer program for vehicle control.

### BACKGROUND

A technique to automatically drive a vehicle or to assist a vehicle driver in driving has been researched. Such a technique estimates the position of a vehicle and controls travel of the vehicle, based on the estimated position. However, since the accuracy of estimation of the position of the vehicle may be insufficient in some cases, a proposed technique modifies, for example, a parameter for controlling a vehicle, depending on the accuracy of estimation of the position of the vehicle (see Japanese Unexamined Patent Publication JP2015-36840A).

In the technique described in JP2015-36840A, an autonomously traveling vehicle estimates the current position and orientation of the vehicle by comparing measured topographic features around the vehicle with a map, and evaluates reliability of the result of estimation of the current position and orientation. Based on the evaluation of reliability, the autonomously traveling vehicle modifies at least a control parameter or control input for controlling the vehicle to travel along a set trajectory.

### SUMMARY

Incorrect estimation of the position of a vehicle may not lead to control travel of the vehicle appropriately. It is therefore desirable that whether the result of estimation of the position of the vehicle is accurate can be determined.

It is an object of the present invention to provide a vehicle controller that can determine whether the result of estimation of the position of the vehicle is correct.

According to an embodiment, a vehicle controller is provided. The vehicle controller includes a memory configured to store map information representing features on or around a road; and a processor configured to: estimate the position of a vehicle by comparing an image representing an area around the vehicle generated by a camera mounted on the vehicle with the map information, set a planned trajectory of the vehicle along a lane including the estimated position of the vehicle by referring to the map information, detect a stationary object in the area around the vehicle from the image or a ranging signal obtained by a distance sensor mounted on the vehicle for detecting the distance to an object in the area around the vehicle, determine whether the detected stationary object is on the planned trajectory, and determine that the estimated position of the vehicle is incorrect, when the stationary object is on the planned trajectory.

The processor of the vehicle controller preferably is further configured to warn a driver that the estimated position of the vehicle is incorrect, when it is determined that the estimated position of the vehicle is incorrect.

According to another embodiment, a method for vehicle control is provided. The method includes: estimating the position of a vehicle by comparing an image representing an area around the vehicle generated by a camera mounted on the vehicle with map information representing features on or around a road; setting a planned trajectory of the vehicle along a lane including the estimated position of the vehicle by referring to the map information; detecting a stationary object in the area around the vehicle from the image or a ranging signal obtained by a distance sensor mounted on the vehicle for detecting the distance to an object in the area around the vehicle; determining whether the stationary object is on the planned trajectory; and determining that the estimated position of the vehicle is incorrect, when the stationary object is on the planned trajectory.

According to still another embodiment, a non-transitory recording medium that stores a computer program for vehicle control is provided. The computer program includes instructions causing a processor mounted on a vehicle to execute a process including: estimating the position of the vehicle by comparing an image representing an area around the vehicle generated by a camera mounted on the vehicle with map information representing features on or around a road; setting a planned trajectory of the vehicle along a lane including the estimated position of the vehicle by referring to the map information; detecting a stationary object in the area around the vehicle from the image or a ranging signal obtained by a distance sensor mounted on the vehicle for detecting the distance to an object in the area around the vehicle; determining whether the stationary object is on the planned trajectory; and determining that the estimated position of the vehicle is incorrect, when the stationary object is on the planned trajectory.

The vehicle controller according to the present disclosure has an advantageous effect of being able to determine whether the result of estimation of the position of the vehicle is correct.

### BRIEF DESCRIPTION OF DRAWINGS

FIG. 1 schematically illustrates the configuration of a vehicle control system equipped with a vehicle controller.

FIG. 2 illustrates the hardware configuration of an electronic control unit, which is an embodiment of the vehicle controller.

FIG. 3 is a functional block diagram of a processor of the electronic control unit, related to a vehicle control process.

FIG. 4 illustrates an example of the positional relationship between a planned trajectory and a stationary object for the case where the estimated current position of the vehicle is incorrect.

FIG. 5 is an operation flowchart of the vehicle control process.

### DESCRIPTION OF EMBODIMENTS

A vehicle controller, a method for vehicle control executed by the vehicle controller, and a computer program for vehicle control will now be described with reference to the attached drawings. The vehicle controller estimates the position of a host vehicle at the time of acquisition of an image of an area around the vehicle (hereafter the “current position” or the “position of the host vehicle”) by comparing the image with map information. The vehicle controller sets a trajectory to be traveled by the vehicle (hereafter a “planned trajectory”) along a lane including the estimated position and being traveled by the vehicle (hereafter a “host vehicle lane”), and further detects a stationary object in the area around the vehicle from the image representing the area around the vehicle or a ranging signal indicating the distance to an object in the area around the vehicle. The vehicle controller determines whether the stationary object is on the planned trajectory, and determines that the estimated position of the vehicle is incorrect, when the stationary object is on the planned trajectory.

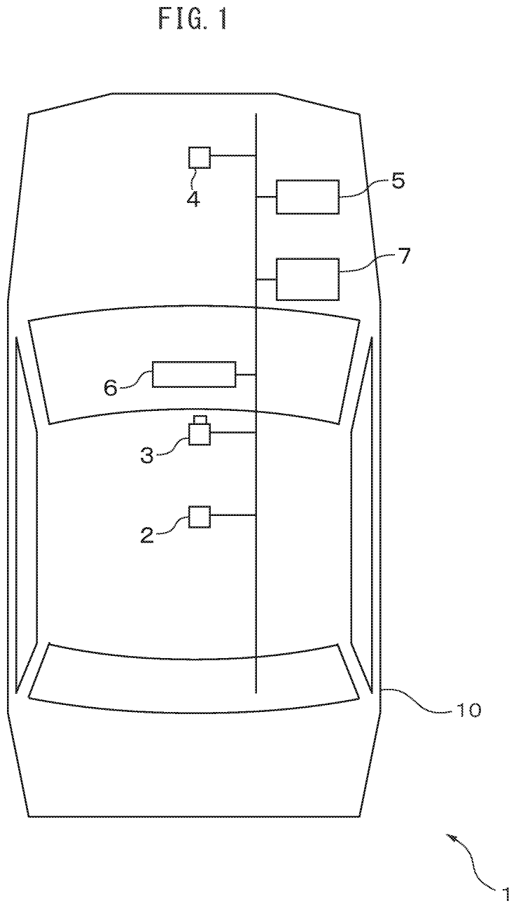

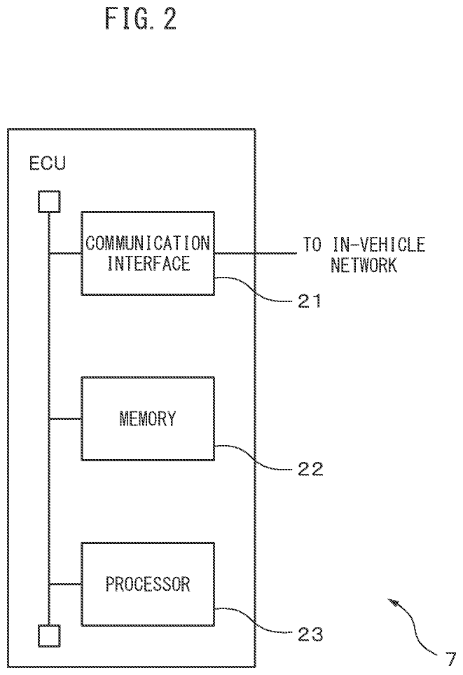

FIG. 1 schematically illustrates the configuration of a vehicle control system equipped with the vehicle controller. FIG. 2 illustrates the hardware configuration of an electronic control unit, which is an embodiment of the vehicle controller. In the present embodiment, the vehicle control system 1, which is mounted on a vehicle 10 and controls the vehicle 10, includes a GPS receiver 2, a camera 3, a distance sensor 4, a storage device 5, a notification device 6, and an electronic control unit (ECU) 7, which is an example of the vehicle controller. The GPS receiver 2, the camera 3, the distance sensor 4, the storage device 5, and the notification device 6 are communicably connected to the ECU 7 via an in-vehicle network conforming to a standard such as a controller area network. The vehicle control system 1 may include a navigation device (not illustrated) for searching for a planned travel route to a destination, and further include a wireless communication device (not illustrated) for wireless communication with another device.

The GPS receiver 2, which is an example of a position measuring unit, receives GPS signals from GPS satellites at predetermined intervals, and determines the position of the vehicle 10, based on the received GPS signals. The GPS receiver 2 outputs positioning information indicating the result of determination of the position of the vehicle 10 based on the GPS signals to the ECU 7 via the in-vehicle network at predetermined intervals. Instead of the GPS receiver 2, the vehicle 10 may include a receiver conforming to another satellite positioning system. In this case, the receiver determines the position of the vehicle 10.

The camera 3, which is an example of an image capturing unit that generates an image representing an area around the vehicle 10, includes a two-dimensional detector constructed from an array of optoelectronic transducers, such as CCD or C-MOS, having sensitivity to visible light and a focusing optical system that forms an image of a target region on the two-dimensional detector. The camera 3 is mounted, for example, in the interior of the vehicle 10 so as to be oriented, for example, to the front of the vehicle 10. The camera 3 takes pictures of a region in front of the vehicle 10 every predetermined capturing period (e.g., 1/30 to 1/10 seconds), and generates images representing the region. Each image obtained by the camera 3 may be a color or grayscale image. The vehicle 10 may include multiple cameras taking pictures in different orientations or having different focal lengths.

Every time an image is generated, the camera 3 outputs the generated image to the ECU 7 via the in-vehicle network.

The distance sensor 4, which is an example of a distance measuring unit that detects the distance to an object in the area around the vehicle 10, may be, for example, LiDAR or radar. The distance sensor 4 generates a ranging signal indicating the distance to an object for each bearing, at predetermined intervals. Every time a ranging signal is generated, the distance sensor 4 outputs the generated ranging signal to the ECU 7 via the in-vehicle network.

The storage device 5, which is an example of the storage unit, includes, for example, at least one of the following: a hard disk drive, a nonvolatile semiconductor memory, and an optical medium and an access device therefor. The storage device 5 stores a high-precision map, which an example of the map information. The high-precision map includes information indicating features on or around a road included in a predetermined region represented in the high-precision map. Examples of the features on or around a road include road markings, such as lane-dividing lines or stop lines, traffic signs, curbstones, and road walls.

The storage device 5 may further include a processor for executing, for example, a process to update a high-precision map and a process related to a request from the ECU 7 to read out a high-precision map. In this case, for example, every time the vehicle 10 moves a predetermined distance, the storage device 5 may transmit a request to obtain a high-precision map, together with the current position of the vehicle 10, to a map server via the wireless communication device (not illustrated). The storage device 5 may then receive a high-precision map of a predetermined region around the current position of the vehicle 10 from the map server via the wireless communication device. Upon receiving a request from the ECU 7 to read out a high-precision map, the storage device 5 cuts out that portion of a high-precision map stored therein which includes the current position of the vehicle 10 and which represents a region smaller than the predetermined region, and outputs the cutout portion to the ECU 7 via the in-vehicle network.

The notification device 6 is provided in the interior of the vehicle 10, and makes predetermined notification to the driver by voice or display of characters, an icon, or an image. To achieve this, the notification device 6 includes, for example, at least a speaker or a display. The notification device 6 notifies the driver of notification information received from the ECU 7. The notification information includes, for example, a message for warning that the result of estimation of the current position of the vehicle 10 is incorrect. The notification information further includes a message for requesting an increase in the degree of the driver's involvement in driving the vehicle 10, e.g., a message for requesting hold of the steering wheel or a message of transfer of driving control to the driver. Upon receiving notification information, the notification device 6 notifies the driver of the message included in the notification information by a voice from the speaker or by an icon, an image, or a message on the display.

The ECU 7 controls travel of the vehicle 10.

As illustrated in FIG. 2, the ECU 7 includes a communication interface 21, a memory 22, and a processor 23. The communication interface 21, the memory 22, and the processor 23 may be configured as separate circuits or a single integrated circuit.

The communication interface 21 includes an interface circuit for connecting the ECU 7 to the in-vehicle network. Every time positioning information is received from the GPS receiver 2, the communication interface 21 passes the received positioning information to the processor 23. Every time an image is received from the camera 3, the communication interface 21 passes the received image to the processor 23. In addition, every time a ranging signal is received from the distance sensor 4, the communication interface 21 passes the received ranging signal to the processor 23. Further, the communication interface 21 passes a high-precision map read from the storage device 5 to the processor 23.

The memory 22, which is another example of the storage unit, includes, for example, volatile and nonvolatile semiconductor memories, and stores various types of data used in a vehicle control process executed by the processor 23 of the ECU 7. For example, the memory 22 stores images of an area around the vehicle 10, ranging signals, and the results of determination of the position of the vehicle 10 by the GPS receiver 2. In addition, the memory 22 stores a high-precision map read from the storage device 5, parameters of the camera 3 indicating the focal length, the angle of view, the orientation, and the mounted position, and a set of parameters for specifying a classifier used for detecting features. Further, the memory 22 temporarily stores various types of data generated during the vehicle control process.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes the vehicle control process on the vehicle 10.

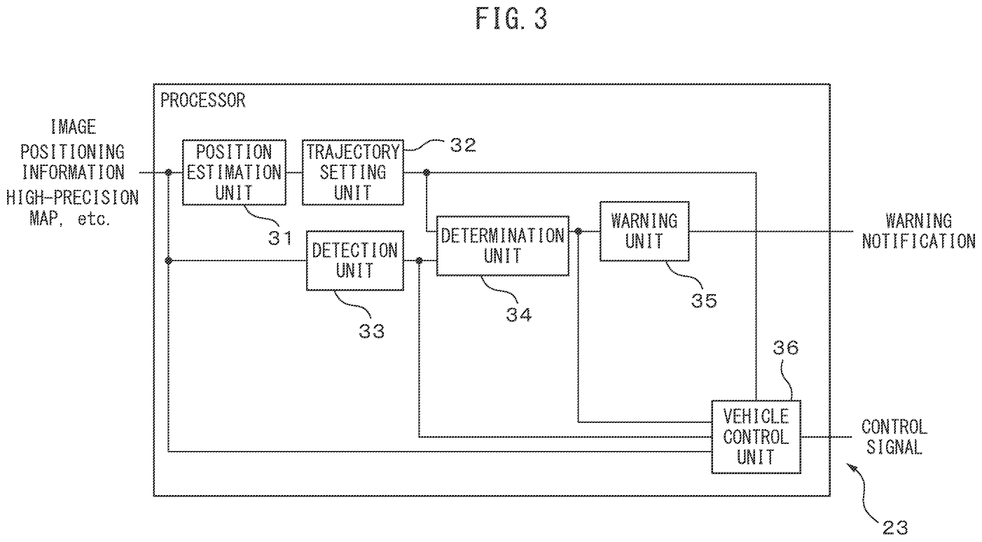

FIG. 3 is a functional block diagram of the processor 23, related to the vehicle control process. The processor 23 includes a position estimation unit 31, a trajectory setting unit 32, a detection unit 33, a determination unit 34, a warning unit 35, and a vehicle control unit 36. These units included in the processor 23 are functional modules, for example, implemented by a computer program executed by the processor 23, or may be dedicated operating circuits provided in the processor 23.

The position estimation unit 31 estimates the current position of the vehicle 10. In the present embodiment, the position estimation unit 31 estimates the current position of the vehicle 10 by comparing an image obtained by the camera 3 with a high-precision map. To achieve this, for example, the position estimation unit 31 inputs an image into a classifier to detect features on or around a road represented in the image. As such a classifier, the position estimation unit 31 can use, for example, a deep neural network (DNN) having architecture of a convolutional neural network (CNN) type, such as Single Shot MultiBox Detector (SSD) or Faster R-CNN. Such a classifier is trained in advance to detect a feature to be detected, from an image. Assuming the current position and orientation of the vehicle 10, the position estimation unit 31 projects features detected from the image onto the high-precision map or features on or near the road around the vehicle 10 in the high-precision map onto the image by referring to parameters of the camera 3. To this end, the position estimation unit 31 may use the position of the vehicle 10 indicated by the latest positioning information obtained by the GPS receiver 2 as an initial value of the assumed current position of the vehicle 10. Alternatively, the position estimation unit 31 may use a position corrected from the last estimated position of the vehicle 10 by referring to odometry information of the vehicle 10 obtained by a wheel speed sensor (not illustrated) as an initial value of the assumed current position of the vehicle 10. While changing the assumed current position and orientation of the vehicle 10, the position estimation unit 31 repeats the above-described processing. The position estimation unit 31 then estimates the current position and orientation of the vehicle 10 to be the position and orientation of the vehicle 10 for the case where the features detected from the image match those represented in the high-precision map the best. In addition, the position estimation unit 31 detects a lane including the estimated current position of the vehicle 10 among the individual lanes represented in the high-precision map as a host vehicle lane.

The position estimation unit 31 notifies the trajectory setting unit 32 and the vehicle control unit 36 of information indicating the detected host vehicle lane and the current position of the vehicle 10.

Upon receiving the information indicating the detected host vehicle lane and the current position of the vehicle 10 from the position estimation unit 31, the trajectory setting unit 32 sets a planned trajectory from the current position of the vehicle 10 to a predetermined distance away along the host vehicle lane. The planned trajectory is represented, for example, as a set of target positions of the vehicle 10 at respective times in the section from the current position to a predetermined distance away. For example, the trajectory setting unit 32 sets a planned trajectory on the center of the host vehicle lane by referring to the high-precision map. The trajectory setting unit 32 sets the target positions on the planned trajectory at respective times by setting the speed of the vehicle 10, based on a target speed inputted by the driver via an operating device, the legally permitted speed of a road being traveled by the vehicle 10, or the speed of another vehicle traveling ahead of the vehicle 10.

The trajectory setting unit 32 notifies the determination unit 34 and the vehicle control unit 36 of the set planned trajectory.

The detection unit 33 detects a stationary object in an area around the vehicle 10 from an image obtained by the camera 3 or a ranging signal obtained by the distance sensor 4. A stationary object to be detected is a three-dimensional structure located in a region impassable to the vehicle 10 in an area around a road, such as a guardrail, a noise-blocking wall, or a pole. For example, the detection unit 33 inputs an image into a classifier to detect a stationary object represented in the image. As such a classifier, the detection unit 33 can use, for example, a classifier similar to that described in relation to the position estimation unit 31, such as SSD or Faster R-CNN. Alternatively, as such a classifier, the detection unit 33 may use a DNN for semantic segmentation that identifies the type of object represented in each pixel, such as Fully Convolutional Network (FCN) or U-Net. Such a classifier is trained in advance to detect a stationary object to be detected, from an image.

When a stationary object is detected from a ranging signal, too, the detection unit 33 may input the ranging signal into a classifier that has been trained to detect a stationary object from a ranging signal, thereby detecting the stationary object. In this case, since the bearing of the stationary object is identified in the ranging signal by the classifier, the detection unit 33 can estimate the distance from the vehicle 10 to the detected stationary object by referring to the distance value of the ranging signal in the identified bearing.

The detection unit 33 notifies the determination unit 34 of information indicating the position of the stationary object in the image or information indicating the distance and bearing to the stationary object detected from the ranging signal.

The determination unit 34 determines whether the stationary object detected by the detection unit 33 is on the planned trajectory.

When the stationary object is detected from an image generated by the camera 3, the determination unit 34 estimates the position of the stationary object in the real space represented by a coordinate system with a predetermined point of the vehicle 10 (e.g., the center of the front edge of the vehicle 10) as the origin, from the position of the stationary object in the image. To this end, the determination unit 34 can estimate the direction from the predetermined point to the stationary object, based on the position of pixels representing the stationary object in the image and parameters such as the focal length and the mounted position of the camera 3. From the distance to an object in the direction represented in a ranging signal generated by the distance sensor 4, the determination unit 34 can further estimate the distance to the stationary object. When the stationary object is detected from a ranging signal generated by the distance sensor 4, the real-space position of the stationary object is estimated on the basis of the bearing and distance from the position at which the distance sensor 4 is provided on the vehicle 10 to the stationary object.

The determination unit 34 determines whether the position of the stationary object overlaps the planned trajectory, and, when they overlap, determines that the stationary object is on the planned trajectory. Since the vehicle 10 inevitably has a certain width, the determination unit 34 may determine that the position of the stationary object overlaps the planned trajectory, i.e., the stationary object is on the planned trajectory, when the distance between the stationary object and the planned trajectory is not greater than a length corresponding to the width of the vehicle 10. When no stationary object is detected, the determination unit 34 determines that no stationary object is on the planned trajectory. When there is a stationary object on the planned trajectory, the determination unit 34 determines that the current position of the vehicle 10 is incorrect. The determination unit 34 may determine that the current position of the vehicle 10 is incorrect, when it is successively determined that there is a stationary object on the planned trajectory more than a predetermined number of times that is not less than two. When no stationary object is on the planned trajectory, the determination unit 34 determines that the current position of the vehicle 10 is correct.

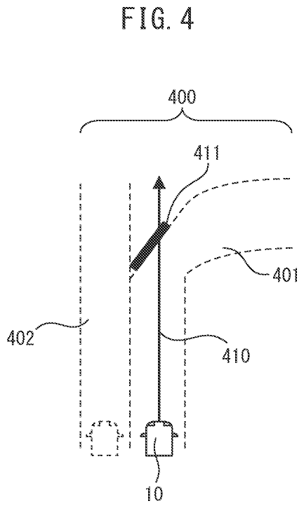

FIG. 4 illustrates an example of the positional relationship between a planned trajectory and a stationary object for the case where the estimated current position of the vehicle 10 is incorrect. In this example, the vehicle 10 is traveling on a lane 401 diverging rightward from a road 400 with respect to the travel direction of the vehicle 10 among two lanes included in the road 400. Assume that, however, the current position of the vehicle 10 is erroneously estimated to be on a straight lane 402 on the left with respect to the travel direction of the vehicle 10 among the two lanes of the road 400. In this case, a planned trajectory 410 is set along the lane 402, and is thus a straight trajectory. However, since the actual position of the vehicle 10 is on the lane 401 diverging rightward, as described above, a road wall 411 located between the lanes 401 and 402, which is an example of the stationary object, is on the planned trajectory 410. This suggests that the result of estimation of the current position of the vehicle 10 is incorrect.

The determination unit 34 notifies the warning unit 35 and the vehicle control unit 36 of the result of determination whether the current position of the vehicle 10 is correct.

When it is determined that the current position of the vehicle 10 is incorrect, the determination unit 34 may further determine to increase the degree of the driver's involvement in driving the vehicle 10. For example, when the ECU 7 is controlling travel of the vehicle 10 on condition that the driver watches around the vehicle 10, the determination unit 34 may request the driver to hold the steering wheel. Alternatively, the determination unit 34 may request transfer of driving control of the vehicle 10 from the ECU 7 to the driver. The determination unit 34 then notifies the warning unit 35 and the vehicle control unit 36 of the request to increase the degree of the driver's involvement in driving the vehicle 10.

The warning unit 35 generates notification information including a message for notification that the result of estimation of the current position of the vehicle 10 is inaccurate, when notified by the determination unit 34 of the result of determination that the current position of the vehicle 10 is incorrect. In addition, when notified by the determination unit 34 of a request to increase the degree of the driver's involvement in driving the vehicle 10, the warning unit 35 includes a message representing the request in the notification information. The warning unit 35 outputs the generated notification information to the notification device 6 via the communication interface 21 to notify the driver of the warning or request represented by the notification information.

The vehicle control unit 36 executes autonomous driving control of the vehicle 10 so that the vehicle 10 travels along the planned trajectory, when notified by the determination unit 34 of the result of determination that the current position of the vehicle 10 is correct. For example, the vehicle control unit 36 determines the steering angle for the vehicle 10 to travel along the planned trajectory, by referring to the current position of the vehicle 10 and the planned trajectory, and outputs a control signal depending on the steering angle to an actuator (not illustrated) that controls the steering wheel of the vehicle 10. Further, the vehicle control unit 36 determines target acceleration of the vehicle 10 according to a target speed of the vehicle 10 and the current speed of the vehicle 10 measured by a vehicle speed sensor (not illustrated), and sets the degree of accelerator opening or the amount of braking so that the acceleration of the vehicle 10 is equal to the target acceleration. The vehicle control unit 36 then determines the amount of fuel injection according to the set degree of accelerator opening, and outputs a control signal depending on the amount of fuel injection to a fuel injector of an engine of the vehicle 10. Alternatively, the vehicle control unit 36 outputs a control signal depending on the set amount of braking to the brake of the vehicle 10. The vehicle control unit 36 identifies the legally permitted speed of a road being traveled by the vehicle 10 by referring to a high-precision map, and sets the target speed of the vehicle 10 according to the legally permitted speed. Alternatively, the vehicle control unit 36 may set the target speed of the vehicle 10 so as to keep the distance to another vehicle traveling ahead of the vehicle 10 constant.

When notified by the determination unit 34 of the result of determination that the current position of the vehicle 10 is incorrect, the vehicle control unit 36 may modify the planned trajectory so that the path of the vehicle 10 will be changed before a collision of the vehicle 10 with the stationary object. The vehicle control unit 36 then executes autonomous driving control of the vehicle 10 so that the vehicle 10 travels along the modified planned trajectory. At this control, the vehicle control unit 36 may decelerate the vehicle 10 to a speed such that the vehicle 10 can stop before a collision with the stationary object. When notified by the determination unit 34 of transfer of drive control of the vehicle 10 from the ECU 7 to the driver, the vehicle control unit 36 stops autonomous driving control of the vehicle 10 after a predetermined period from notification of the request of transfer to the driver. Thereafter, the vehicle control unit 36 controls the vehicle 10 according to the driver's operation of the vehicle 10.

In addition, the vehicle control unit 36 may modify the planned trajectory as necessary so that the vehicle 10 will not collide with a moving object, such as another vehicle traveling in an area around the vehicle 10 or a pedestrian. In this case, the classifier used by the detection unit 33 is trained in advance to detect a moving object as well as a stationary object from an image. The detection unit 33 inputs an image obtained by the camera 3 or a ranging signal obtained by the distance sensor 4 into the classifier to detect a moving object together with a stationary object. The vehicle control unit 36 applies a predetermined tracking technique, such as the KLT method, to the moving object detected by the detection unit 33 from each of time-series images or ranging signals, to track the moving object, thereby determining the trajectory of the moving object. The vehicle control unit 36 predicts a future trajectory of the moving object by applying a predetermined prediction filter to the determined trajectory, and modifies the planned trajectory so that the planned trajectory is separated from the predicted trajectory at least a predetermined distance.

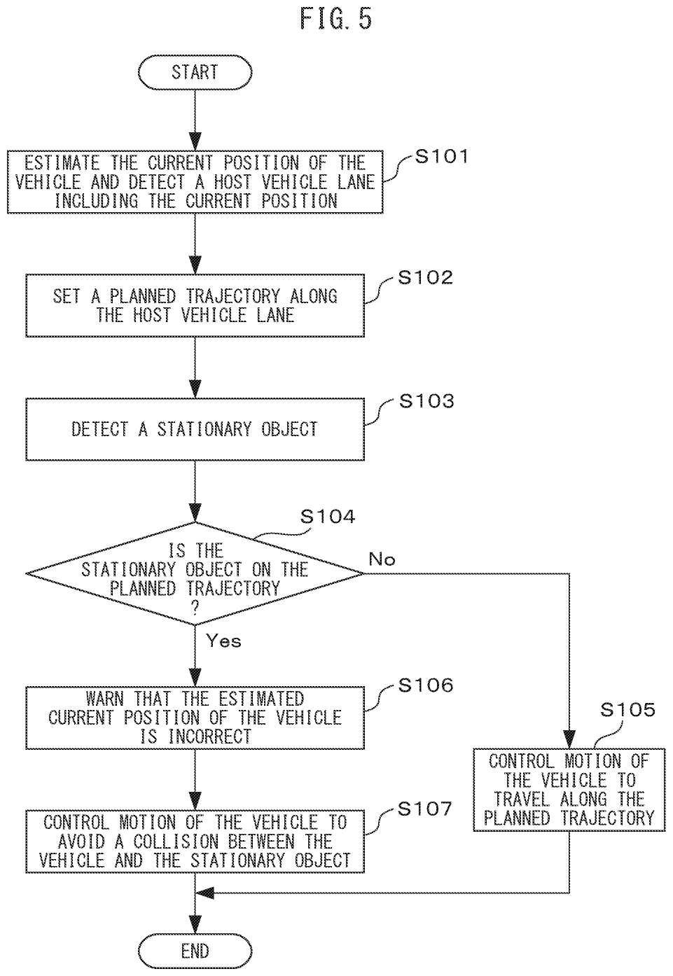

FIG. 5 is an operation flowchart of the vehicle control process executed by the processor 23. The processor 23 executes the vehicle control process in accordance with the operation flowchart described below at predetermined intervals.

The position estimation unit 31 of the processor 23 estimates the current position of the vehicle 10 by comparing an image obtained by the camera 3 with a high-precision map, and detects a host vehicle lane, based on the estimated current position (step S101). The trajectory setting unit 32 of the processor 23 sets a planned trajectory from the current position of the vehicle 10 to a predetermined distance away along the host vehicle lane (step S102).

The detection unit 33 of the processor 23 detects a stationary object in an area around the vehicle 10 from an image obtained by the camera 3 or a ranging signal obtained by the distance sensor 4 (step S103). The determination unit 34 of the processor 23 determines whether the detected stationary object is on the planned trajectory (step S104).

When the stationary object is not on the planned trajectory (No in step S104), the determination unit 34 determines that the current position of the vehicle 10 is correct. The vehicle control unit 36 of the processor 23 executes autonomous driving control of the vehicle 10 so that the vehicle 10 travels along the planned trajectory (step S105).

When the stationary object is on the planned trajectory (Yes in step S104), the determination unit 34 determines that the estimated current position of the vehicle 10 is incorrect. The warning unit 35 of the processor 23 warns the driver that the estimated current position of the vehicle 10 is incorrect, via the notification device 6 (step S106). The warning unit 35 may further notify the driver of a request to increase the driver's involvement in driving the vehicle 10, via the notification device 6, as described above. The vehicle control unit 36 modifies the planned trajectory so that the vehicle 10 will not collide with the stationary object, and controls the vehicle 10 so that the vehicle 10 travels along the modified planned trajectory (step S107). After step S105 or S107, the processor 23 terminates the vehicle control process.

As has been described above, the vehicle controller estimates the current position of the vehicle by comparing an image obtained by a vehicle-mounted camera with a high-precision map, detects a host vehicle lane on which the vehicle is traveling, based on the estimated current position, and sets a planned trajectory along the host vehicle lane. In addition, the vehicle controller detects a stationary object in an area around the vehicle from an image obtained by the vehicle-mounted camera or a ranging signal obtained by a distance sensor, and determines whether the detected stationary object is on the planned trajectory. When the stationary object is on the planned trajectory, the vehicle controller determines that the estimated current position of the vehicle is incorrect. In this way, the vehicle controller determines whether the current position of the vehicle is incorrect, based on the positional relationship between the stationary object and the planned trajectory set along the host vehicle lane, where there cannot be a stationary object, and thus can accurately determine whether the result of estimation of the current position of the vehicle is correct.

The computer program for achieving the functions of the processor 23 of the ECU 7 according to the embodiment or modified examples may be provided in a form recorded on a computer-readable portable storage medium, such as a semiconductor memory, a magnetic medium, or an optical medium.

As described above, those skilled in the art may make various modifications according to embodiments within the scope of the present invention.

What is claimed is:

1. A vehicle controller comprising:
a memory configured to store map information representing features on or around a road; and
a processor configured to:
estimate the position of a vehicle by comparing an image representing an area around the vehicle generated by a camera mounted on the vehicle with the map information,
set a planned trajectory of the vehicle along a lane including the estimated position of the vehicle by referring to the map information,
detect a stationary object in the area around the vehicle from the image or a ranging signal obtained by a distance sensor mounted on the vehicle for detecting the distance to an object in the area around the vehicle,
determine whether the stationary object is on the planned trajectory, and
determine that the estimated position of the vehicle is incorrect, when the stationary object is on the planned trajectory.

2. The vehicle controller according to claim 1, wherein the processor is further configured to warn a driver that the estimated position of the vehicle is incorrect, when it is determined that the estimated position of the vehicle is incorrect.

3. A method for vehicle control, comprising:
estimating the position of a vehicle by comparing an image representing an area around the vehicle generated by a camera mounted on the vehicle with map information representing features on or around a road;
setting a planned trajectory of the vehicle along a lane including the estimated position of the vehicle by referring to the map information;
detecting a stationary object in the area around the vehicle from the image or a ranging signal obtained by a distance sensor mounted on the vehicle for detecting the distance to an object in the area around the vehicle;
determining whether the stationary object is on the planned trajectory; and
determining that the estimated position of the vehicle is incorrect, when the stationary object is on the planned trajectory.

4. A non-transitory recording medium that stores a computer program for vehicle control, the computer program causing a processor mounted on a vehicle to execute a process comprising:
estimating the position of the vehicle by comparing an image representing an area around the vehicle generated by a camera mounted on the vehicle with map information representing features on or around a road;
setting a planned trajectory of the vehicle along a lane including the estimated position of the vehicle by referring to the map information;
detecting a stationary object in the area around the vehicle from the image or a ranging signal obtained by a distance sensor mounted on the vehicle for detecting the distance to an object in the area around the vehicle;
determining whether the stationary object is on the planned trajectory; and
determining that the estimated position of the vehicle is incorrect, when the stationary object is on the planned trajectory.
